(19) United States
(12) Patent Application Publication
(10) Pub. No.: US 2005/0015528 A1
(43) Pub. Date: Jan. 20, 2005

(54) Personal computer based on wireless human-machine interactive device and method of transmitting data thereof

(76) Inventor: Dayu Du, Beijing (CN)

Correspondence Address: HARNESS, DICKEY & PIERCE, P.L.C., P.O. BOX 828, BLOOMFIELD HILLS, MI, 48303, US

(21) Appl. No.: 10/914,021

(22) Filed: Aug. 6, 2004

Related U.S. Application Data
(63) Continuation of application No. PCT/CN02/00078, filed on Feb. 9, 2002.

(51) Int. Cl. G06F 1/16

(52) U.S. Cl. 710/68

(57) ABSTRACT

Method for transmitting data in a personal computer based on wireless human-machine interactive device, comprising at least following steps: inputting event information by user via an external device connected to the wireless human-machine interactive device and; capturing the information stream by host system and stimulating burst the event received from input of user; converting and compressing the image and voice data of the burst event by host system, and transmitting to interactive device in manner of wireless; the wireless interactive device reverts the data stream and outputs to display and voice device. The host system is separated from display device and external device, the transmission manner is wireless and the transmission is security and credibility. The burden of network is low and architecture is flexible. The strong function of software and hardware of computer host can be fully used for providing mobile official business and wireless entertainment to users. The radio of performance and price is high and easy to extend for new application of wireless multimedia.

### CROSS-REFERENCE TO RELATED APPLICATIONS

This application is a continuation of International Application No. PCT/CN02/00078 filed on Feb. 9, 2002. The disclosure of the above application is incorporated herein by reference.

### FIELD OF THE INVENTION

The invention relates to a PC (Personal Computer) and method for transmitting data, especially to a PC based on wireless human-machine interactive device and method for transmitting data thereof; it belongs to computer technology field.

### BACKGROUND OF THE INVENTION

At present, the PC is divided into three types: the desktop computer, the notebook computer and the Personal Digital Assistance (PDA). The desktop computer has powerful functions and is not expensive, so it is the main type of the PC; the notebook computer can be moved easily, but it is expensive; the PDA is smaller and more flexible, and it is mainly to store personal data, schedule and for instant message transfer.

Every type of the PC mentioned above has its own advantages and disadvantages. For example, some disadvantages of the desktop computer are as follow: the host computer and display are immobile and have to occupy a larger desktop area; cables used to connect the host, the display, the keyboard and the mouse are not tidy; the user want to sit properly to operate the computer that will have a sore waist and an aching back easily; further, the desktop computer cannot be moved, and this is not suitable in a home environment, while ideal computer is wireless, movable and multimedia information device. The notebook computer and PDA have advantages of mobile work and can be moved easily such that user can work with this computer on comfortable environment such as sofa or bed, but they are not as powerful as desktop computer and do not have the same performance price ratio as the desktop computer. A PDA has a small size display, less application software and simple functions, although some flat-panel displays with powerful functions have appeared recently, such as Tablet PC that has a display with more than 800×600 resolution, larger memory and hard disk, powerful operating system, and manual input.

No matter how rapid development of the PC technology, in the foreseeable future the desktop computer will be the main type of the PC. Therefore, if the desktop computer can be further developed, making its application filed wider, taking advantages of notebook computer and PDA on wireless communication, connecting above three types of computers, providing better user experience, and improving performance price ratio, the formation and development of next generation personal computer will be impressed.

A China patent (Number: CN 1309362A, Date: 22^{nd}, Aug., 2001) discloses a PC that separates the display, the keyboard and the mouse from the host computer. Said patent PC is characterized that includes a wireless transmission device in the host computer and a wireless transmission device in equipment; and each of the two wireless transmission devices includes a radio transmitter and a radio receiver. The wireless transmission device in the computer is directly connected to the display port, the keyboard port and the mouse port by connection cables; and the wireless transmission device in equipment is connected to the display, the keyboard and the mouse. Wherein, the display image signal is first transferred from the computer to the wireless transmission device in the computer and then transmitted in wireless; the wireless transmission device in equipment receives said display image signal and then transfers to the display; the keyboard and mouse signal is first transferred to the wireless transmission device in equipment and then transmitted; the wireless transmission device in the computer receives said keyboard and mouse signal and transfers to the computer. Considering present technology, this PC has the following disadvantages:
(1) The display image signal, the keyboard signal and the mouse signal are hardware level signal, so the data volume of these signals is huge (especially the display image signal); Present bandwidth of the wireless communication is difficult to achieve the requirement, even the requirement is achieved afterward, it will only waste the bandwidth of the wireless communication, because it is possible to obtain these signals on a higher abstracted level of data form the operating system efficiently;
(2) At present, the display image signal is an analog signal, and in the analog signal wireless communication, packets are easily lost, data are easily damaged and signal bandwidth is greatly fluctuated, it cause a question that whether the analog display image signal which has been transmitted in wireless will be accepted by user;
(3) There is no any signal compression to reduce the burden of wireless network for wireless transmission of huge data;
(4) The PC cannot process sound signal and new type input such as touch screen input, handwriting input and voice input;
(5) Since the wireless transmission device in equipment is connected with the display, the keyboard and the mouse in cables; the PC still belongs to desktop computer, it is difficult to move easily and operate comfortable; in this case, the separation of peripherals with the computer has no obvious advantages.

### SUMMARY OF THE INVENTION

One objective of the invention is to provide a PC based on wireless human-machine interactive device and method for transmitting data thereof; the invention separates the host computer with its display and peripherals, deploys wireless data communication, has a secure and reliable data transmission, and reduce the burden of network.

Another objective of the invention is to provide a PC based on wireless human-machine interactive device and method for transmitting data, the system architecture of PC is flexible, so it satisfies various application requirements.

Objectives of the invention are implemented with the following technical scheme:

A personal computer (PC) based on wireless human-machine interactive device, at least comprises: a host computer, a display, and peripherals of the host computer, wherein, a wireless human-machine interactive device is set between the host computer and the peripherals as well as the display; wherein,

The host computer connects with a data capture and compression device and a duplex wireless communication device through buses; the data capture and compression device obtains data to be transmitted to the wireless human-machine interactive device from the host computer, converts format and compresses the data; and then the duplex wireless communication device transmits the compressed data to the wireless human-machine interactive device in wireless mode;
The wireless human-machine interactive device connects with the display and the peripherals of the host computer; the wireless human-machine interactive device includes a CPU, a memory, a display output device, a sound output device, the duplex wireless communication device, a data receiving and decompression device and also bus extended ports and interfaces of the peripherals of the host computer; wherein, the duplex wireless communication device communicates with the host computer; the data receiving and decompression device receives data transferred from the duplex wireless communication device, decompresses and restores the received data, and transfers to the display output device and sound output device to display image and play music;

An event message inputted from the peripheral connected to the wireless human-machine interactive device being transmitted to the host computer in wireless communication mode, and then the host computer simulates and triggers the input event.

For data compression the data capture and compression device includes a screen image data backup module, a data dynamic comparison module, a data capture module and a data compression module; the screen image data backup module stores last frame of mapping of a screen buffer in real time; the data dynamic comparison module obtains and compares, in real time, current frame of mapping of the screen buffer with last frame stored in the screen image data backup module; the data capture module captures compared dynamic data in certain field and sends the data to the data compression module; the data compression module compresses the data and transfers the compressed data to the duplex wireless communication device; in the wireless human-machine interactive device, the data receiving and decompression device includes two modules: a data decompression module, which decompresses compressed data transferred from the host computer, and an image-padding module, which pads dynamic data on appropriate areas of an image, wherein: the data compression is lossless compression or lossy compression.

Another scheme is: the data capture and compression device of the host computer includes a data capture module and a data compression in real time module; the data capture module is used to obtain a mapping of a screen buffer in real time, and the data compression in real time module makes data compression and format conversion in order to transmit efficiently; the data receiving and decompression module in the wireless human-machine interactive device is data de-compression in real time module which restores data and decompresses received data, wherein: the data compression in real time module deploys MPGE standards to convert a PS data stream to a TS data stream that is suitable for transmission.

For flexibility, the data capture and compression device includes two channels, and there is a switch device in front of the data capture and compression device;

One channel includes a screen image data backup module, a data dynamic comparison module, a data capture module and a data compression module; the screen image data backup module stores last frame of mapping of said screen buffer in real time; the data dynamic comparison module obtains current frame of mapping of the screen buffer in real time and compares current the frame of mapping of the screen buffer with the last frame stored in the screen image data backup module; the data capture module captures compared dynamic data in certain field and sends the dynamic data to the data compression module; the data compression module compresses the dynamic data and transfers the dynamic data to the duplex wireless communication device;

Another channel includes a data capture module and a data compression in real time module; the data capture module is used to obtain a mapping of said screen buffer in real time, and the data compression in real time module makes data compression and format conversion in order to transmit efficiently;

Correspondingly, the data receiving and decompression device in wireless human-machine interactive device also includes two channels:

One channel includes a data decompression module, which decompresses compressed data from the host computer, and an image-padding module, which pads the dynamic data on appropriate areas of an image;

Another channel includes a data decompression in real time module that restores received data to its original format and decompresses received data.

Further, the switch device is a manual switch device or an automatic switch device, the manual switch device is a switch, a special key or a special command, the automatic switch device is an adaptive electronic switch according to event triggered by user input message.

Specially, the duplex wireless communication device is a wireless network card that at least includes an interface unit, a data coding/decoding unit, a radio modulation/demodulation unit and a radio transmitter/receiver unit.

According to requirement, the wireless human-machine interactive device is independent equipment or combined with a display, the wireless human-machine interactive device includes a camera and a visible-telephone software module inside.

Wherein, the wireless human-machine interactive device is more than one.

The peripherals of the host computer are a keyboard, a mouse, a touch screen, a handwriting device or a voice input device.

The connection between wireless human-machine interactive device and peripherals is a wire mode or a wireless mode.

A method of transmitting data for a PC based on wireless human-machine interactive device, comprising:
(1) inputting a user input event message through peripherals connected with wireless human-machine interactive device;
(2) transferring the user input event message from the wireless human-machine interactive device to the host computer in wireless mode;
(3) capturing the user input event message, simulating and triggering the received user input event in the user input event message by the host computer;
(4) converting format of image and sound data streams triggered by the user input event and compressing the image and sound data streams, and then transmitting the image and sound data streams to the wireless human-machine interactive device in wireless mode through the host computer;
(5) recovering the image and sound data streams and sending the image and sound data streams to a display and sound output device by the wireless human-machine interactive device.

Wherein, the wireless communication between a host computer and wireless human-machine interactive device deploys TCP/UDP/IP or other protocols based on IP.

Wherein, the user input event is captured and coded in an event message manner by the wireless human-machine interactive device, and then transmitted in a wireless mode.

Wherein, the converting format of image and sound data streams and compressing the image and sound data streams includes: comparing continuously mapping data of a screen buffer, obtaining sound and image data of dynamic changing field; then converting format of the sound and image data, synthesizing and compressing the sound and image data; correspondingly, after receiving the data, de-converting, de-synthesizing and decompressing the data by the wireless human-machine interactive device, and then displaying and padding the data on appropriate parts of a screen.

Wherein, the compressing the data streams is lossless compressing.

Wherein, the converting format of image and sound data streams and compressing the image and sound data streams includes: obtaining mapping data of a screen buffer, then compressing the data in real time and converting the data to a format that is suitable for transmission; and after receiving the data, de-converting and decompressing the data by the wireless human-machine interactive device.

Wherein, the compressing is MPGE lossy compressing.

Wherein, before the converting format of image and sound data streams and compressing the image and sound data stream, further including: a switching step for selecting different data format conversion and compression according to different data streams, one of the selecting steps is to compare continuously mapping data of a screen buffer to obtain image and audio data of image in dynamic changing areas, and then convert format and synthesize and compress the data; the other of the selecting steps is to obtain mapping data of a screen buffer, and then compress the data in real time and convert to a format that is suitable for transmission; corresponding to different format conversion and data compression, wireless human-machine interactive device has different either to receive, de-synthesize and decompress the data and puts displaying data and padded data on appropriate parts of a display, or receive the data and then convert and decompress.

Wherein, the switching step including: making determination based on a host computer state and data volume to be transferred; if the data volume is small, the first compression method, i.e. a lossless compression method which is only to transfer changed data in real time, is deployed; and if data volume is large, the second compression method which is only to transfer full screen data in real time, i.e. a lossy compression method, is deployed, such to realize the adaptation switch.

Wherein, the switching is a manual switch controlled by switch or key, or an automatic switch which judges according to the setting.

Wherein, when the wireless human-machine interactive device is more than one, the method further including:

Controlling data interaction among the more than one wireless human-machine interactive devices with time-division or frequency-division control.

The advantages of the invention are as following:

Using a wireless human-machine interactive device of the invention, a user can operate software in the host computer, so its powerful computation capability is thoroughly utilized; and the operation is movable, so it is convenient. The wireless human-machine interactive device supports multimedia application, therefore a user may see a movie, listen music or play a video game on it. The PC proposed by the invention is easily extended, and it is a platform to develop new applications. Further, the compression method used in the PC is optionally implemented by software or hardware, so the system supports both office application and home application.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a circuit diagram of a wireless human-machine interactive device of the invention.

FIG. 2 shows a diagram of first system construction embodiment of the invention.

FIG. 3 shows a diagram of second system construction embodiment of the invention.

FIG. 4 shows a diagram of third system construction embodiment of the invention.

FIG. 5 shows a communication flowchart between the host computer and the wireless human-machine interactive device.

FIG. 6 shows first data capture and compression method flowchart in the host computer.

FIG. 7 shows second data capture and compression method flowchart in the host computer.

FIG. 8 shows a flowchart with two data capture and compression methods in FIGS. 6 and 7.

FIG. 9 shows a flowchart of sound data compression.

### DETAILED DESCRIPTION OF THE PREFERRED EMBODIMENTS

The following description of the preferred embodiment(s) is merely exemplary in nature and is in no way intended to limit the invention, its application, or uses.

The invention will be described in more detail with reference to drawings and embodiments.

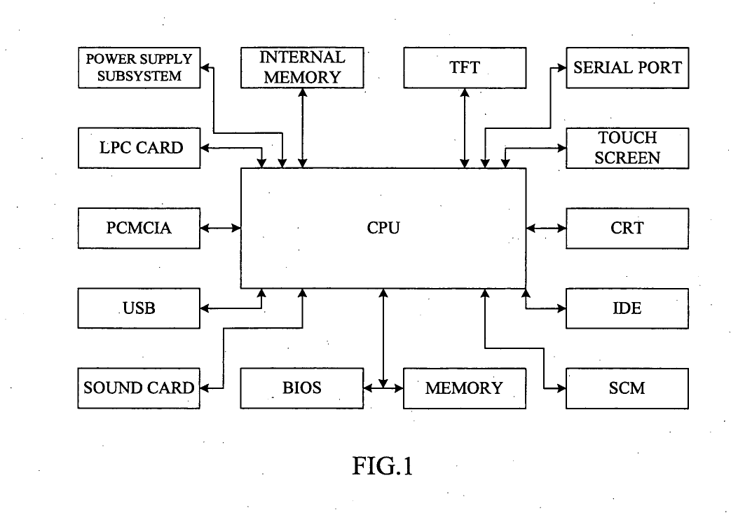

Referring to FIGS. 1, 2, 3 and 4, the invention is a PC based on wireless human-machine interactive device, which at least includes a host computer 1, a peripheral 4 of the computer, a display 3 and a wireless human-machine interactive device 2 between the host computer 1 and the peripheral 4 and display 3. A duplex wireless communication device is added in the host computer that connects to the bus of the computer, including PCI, USB, IEEE1394 and other high-speed bus interfaces. A data capture and compression device inputs data that will be transferred to the wireless human-machine interactive device from the host computer, and after format conversion, compression, the compressed data are sent to the wireless human-machine interactive device through the duplex wireless interactive device in wireless communication manner. The wireless human-machine interactive device is connected to the peripherals and the display.

As shown in FIG. 1, the wireless human-machine interactive device 2 has a CPU (X86, POWER PC, ARM, MIPS, SHX or other RISC processor), a memory, a display controller, a sound processor and other necessary function modules. The wireless human-machine interactive device itself has certain calculation and data processing capability that includes an arithmetic and data processing unit, a display output device, a sound output device, a duplex wireless communication device, the peripherals includes human-machine interactive devices, such as a keyboard, a mouse or a touch screen, a handwriting device or even a voice recognition device. The wireless human-machine interactive device has an operating system or monitor program with the like functions. Said duplex wireless communication device implements communication with said host computer 1, and a reception and decompression device is used to decompress the compressed data from the duplex wireless communication device for outputting image and sound to the display output device and the sound output device. Besides, input events that are produced by said peripherals connected to wireless human-machine interactive device are inputted to the host computer 1 through wireless communication, and those user input events which are received are simulated by the host computer 1.

The conversion between cable wireless human-machine interactive device and wireless human-machine interactive device is implemented with the manner of inserting and lifting from display frame or the like manner. The wireless human-machine interactive device may be an independent information device; when the host computer is shut down or far from the wireless communication scope, it still can run installed software thereof, such as text editor or card game etc.; the application mode can be easily extended and added, such as when installing a camera in the wireless human-machine interactive device and a visible-telephone software with IP protocol in the host computer, the wireless human-machine interactive device will become a visible-telephone based on IP protocol.

In order to realize data compression, the data capture and compression device is consisted of a screen image data backup module, a data dynamic comparison module, a data capture module and a data compression module. The screen image data backup module stores last frame dynamic image of mapping of the screen buffer in real time. The data dynamic comparison module gets current frame of mapping of the screen buffer, and compares the current frame of mapping of the screen buffer with the last frame stored in the screen image data backup module in real time. The data capture module captures the dynamic data that has been compared in certain district and sends the data to the data compression module; data compression module compresses the data and transfers the data to the duplex wireless communication device. In the wireless human-machine interactive device, the data receiving and decompression device has two modules: a data decompression module, which receives and decompresses compressed data from host computer accordingly, and an image-padding module, which pads dynamic data on appropriate areas of an image. The data that is transferred to the wireless human-machine interactive device are only the changing part of two adjacent frames, so the data volume is smaller. So, compression is a lossless compression.

Another compression scheme is as follow: The data capture and compression device of said host computer is consisted of a data capture module and a data compression in real time module. The data capture module is used to obtain data of the screen buffer of mapping in real time, and the data compression in real time module makes compression and data format conversion of the data of the screen buffer to transmit the data efficiently. The data receiving and decompression module in the wireless human-machine interactive device is data decompression in real time module which restores received data to its original format and decompresses received data. Specially, said data compression in real time module deploys MPGE 2 standards to compress and converts a the compressed PS data flow to a TS data flow; in this way, when the system is used for multimedia application, the data transmission is reliable and has a lower network burden.

For flexibility, the data capture and compression device of the host computer has two channels, and there is a switch in front of the data capture and compression device. One channel includes a screen image data backup module, a data dynamic comparison module, a data capture module and a data compression module; the screen image data backup module stores last frame of mapping of the screen buffer in real time; the data dynamic comparison module receives the current frame of mapping of the screen buffer and compares the current frame of mapping of the screen buffer with data stored in the screen image data backup module; the data capture module captures compared dynamic data in certain district, and sends the dynamic data to the data compression module; having compressed, the data compression module transfers said data to the duplex wireless communication device. Another channel includes a data capture module and a data compression in real time module; the data capture module is used to obtain a mapping of the screen buffer in real time, and the data compression in real time module makes compression and data format conversion of data of the screen buffer for transmitting the data efficiently. Correspondingly, the data receiving and decompression device in the wireless human-machine interactive device also has two channels. One channel has a data decompression module, which decompresses compressed data from host computer, and an image-padding module, which pads dynamic data on appropriate areas of an image. Another channel has a data decompression in real time module that restores received data to its original format and decompresses received data.

A lossless compression method, such as LZW compression, is deployed to a text application (such as word), and a lossy compression method, such as in JPEG, is deployed to a picture application such as browsing a picture. In an area of a picture or image, either a lossless compression method or a lossy compression method may be used alone, but alternatively the two compression methods may be used together. An optional item of software is used to select the compression mode, and when the two compression methods are used together, a lossless compression method or a lossy compression method can be dynamically selected according to a type of picture, for example a text file or an image file, the time of data compression, the data volume after compression, and the picture quality etc.

Said dynamic selection is implemented by switch device that can be a manual device or an automatic device. The manual switch device may be a switch or a special defined key or special defined command; the automatic switch device may be an electronic switch that adapts itself according to event triggered by a user input command.

Furthermore, in order to use host computer more efficiently, the host computer may correspond to more than one wireless human-machine interactive device. In this case, the invention will further includes time-division or frequency-division communication control for data interaction of more than one wireless human-machine interactive device.

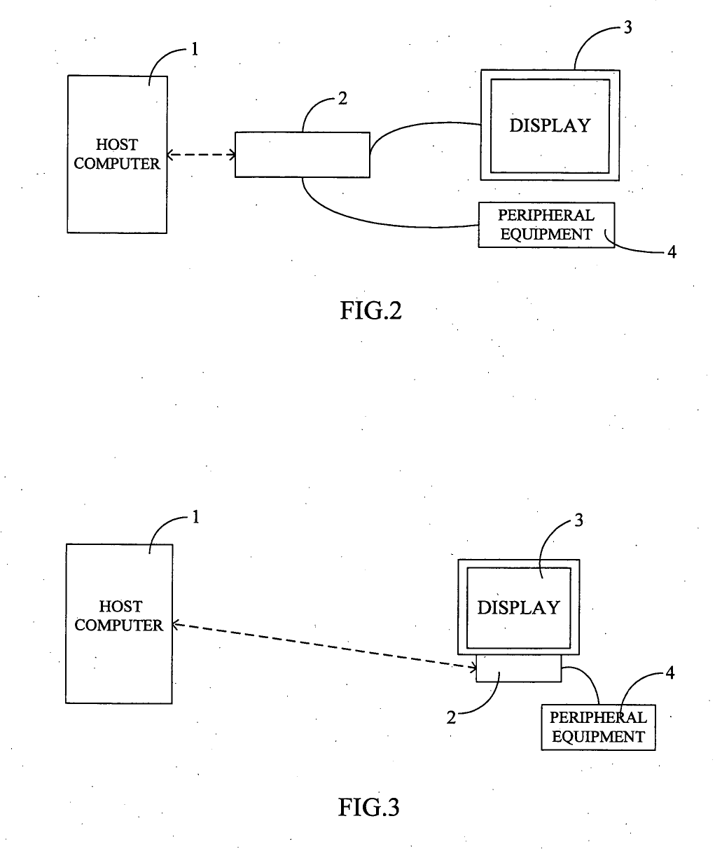

The wireless human-machine interactive device 2 may be independent equipment or combined with the display 3 as a unit; they are shown in FIGS. 2, 3 and 4.

In the first embodiment of the invention, the wireless human-machine interactive device 2 and the display 3 are independent. Specially, a LCD is used as wireless human-machine interactive device that connects to display 3 with a cable; and the LCD is plugged in the display socket of the computer such that the LCD may be either a display connected with common personal computer or a wireless human-machine interactive device supporting multimedia application, as shown in FIG. 2.

The second embodiment of the invention is shown in FIG. 3. The wireless human-machine interactive device 2 is combined with the display 3 as a unit, but the peripheral 4, which may be a mouse, a keyboard or a handwriting recognition device etc., is connected to the wireless human-machine interactive device 2 with an independent cable.

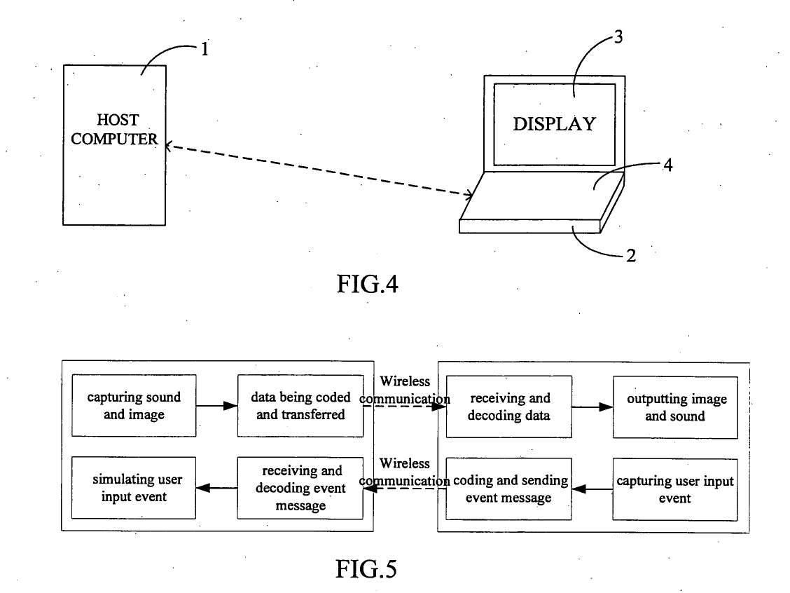

The third embodiment of the invention is shown in FIG. 4. The display of host computer is common CRT or LCD, the peripheral may deploy a mouse, a keyboard or a handwriting touch screen, a handwriting pen, or even sound input as input manner of user. The wireless human-machine interactive device is designed as a notebook computer, the LCD display, keyboard, and touching mouse are combined together. Since computing function and data processing function are implemented on the host computer, the wireless human-machine interactive device having appearance of notebook computer is lighter than notebook computer and have higher price performance radio.

The communication between host computer and wireless human-machine interactive device in the invention is implemented as follow: the message flow of event input by user (such as keyboard and mouse event, or touch screen and handwriting pen event) is transmitted from wireless human-machine interactive device to host computer, the image and sound flow is transmitted form host computer to wireless human-machine interactive device;
Software that runs in the host computer and the wireless human-machine interactive device may communicate in TCP/UDP/IP or other protocols based on IP.

A user input event is captured by software in the wireless human-machine interactive device, and then coded by event message or like manner and sent in a wireless mode; having received said message, software in the wireless human-machine interactive device decodes, and then output to display or sound device.

Coding/decoding of image data and sound data includes signal processing module for the format conversion of image data and sound data, composite and de-composite of image data and sound data, data compression/decompression in software manner or hardware manner, and the like. The special processing of sound is shown in FIG. 9.

FIG. 5 shows the wireless communication procedure. First, software in the wireless human-machine interactive device captures a user input event, such as a keyboard event, a mouse event, a touch screen event or a handwriting event etc., then message of the user input event is coded and sent to the wireless communication device in host computer. Having received said message through the wireless communication device, software in the host computer decodes message code or the like denotation information, and differentiates the event, message, and other information such as event attributes, message type etc., and then according to the type of input event simulates a corresponding user input event in the operating system of the host computer, the operating system runs on the host computer such as Microsoft Window operation system. The operating system updates screen and emit sound: The host computer captures changes of the images on the screen and the sound to be outputted to grab the image and sound data that are then compressed by software, such as LZW compression, or hardware, such as MPEG-2, and sent to the wireless human-machine interactive device through the wireless communication device. Software in the wireless human-machine interactive device decompresses said image and sound data with software or hardware according to compression type of data, and finally the image and sound data are sent to the display and sound devices in the wireless human-machine interactive device.

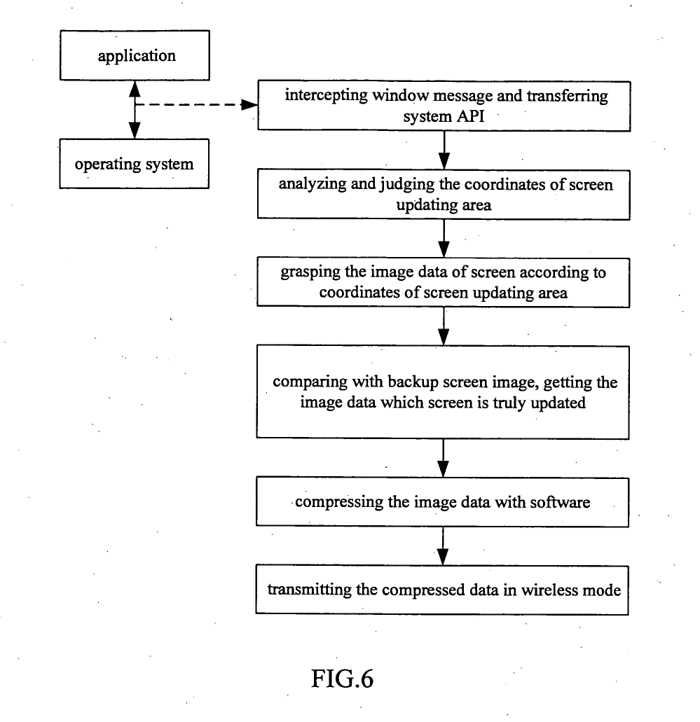

FIG. 6 shows image data conversion and compression flowchart as follow: compare continuously mapping data of the screen buffer to obtain the data of image and sound in the dynamic changing area, then convert, composite and compress the obtained data; correspondingly, said data are de-converted, de-composited and decompressed in the wireless human-machine interactive device after receiving the said data, then the appropriate parts of the screen are displayed or padded. The compression is implemented by computing of the host computer, in result, image data and sound data can be compressed without any video compression card and decompression card.

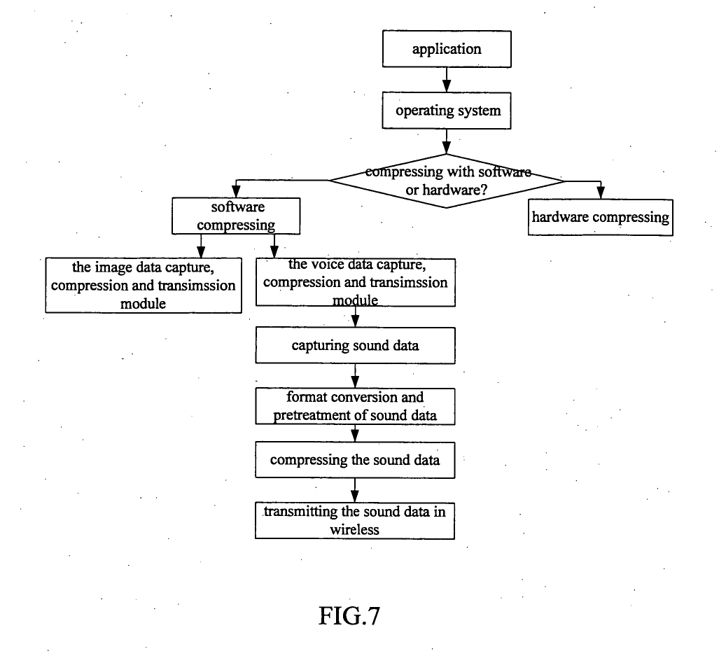

FIG. 7 shows data format conversion and data compression flowchart in the host computer as follow: obtain data of mapping of display buffer, compress the data in real time, and covert the data to the type suitable for transmitting; wireless human-machine interactive device receives the data and then converts and decompress the data.

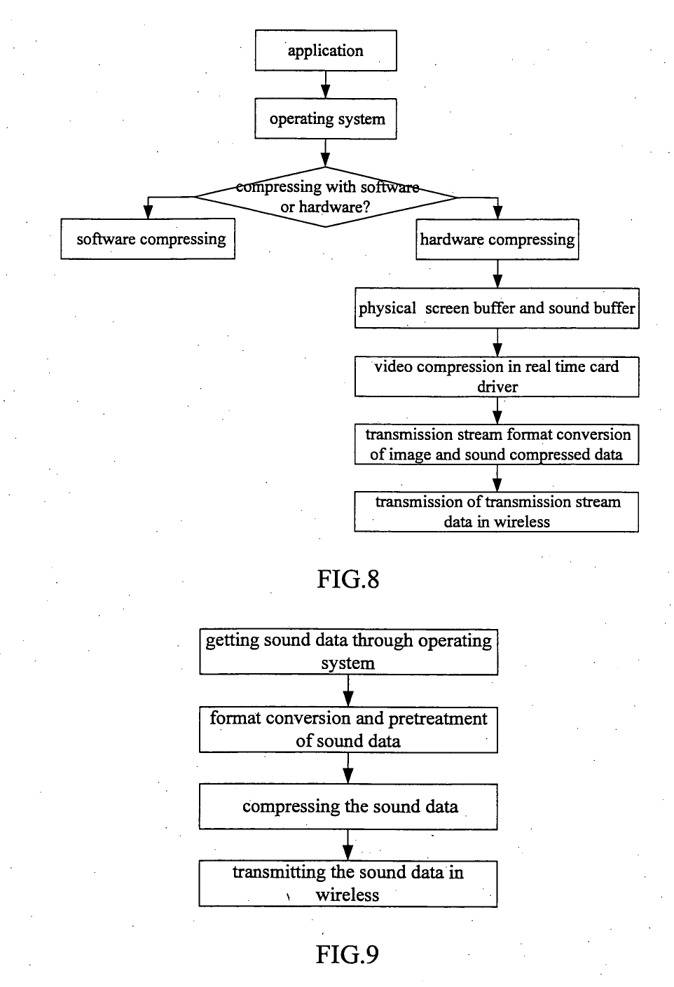

FIG. 8 shows an flowchart for selecting different format conversion and data compression corresponding to different data stream, before data format conversion and data compression, the invention further includes a switch step; wherein, there are two ways to implement the said step of format conversion and data compression, one of which is: comparing continuously mapping data of screen buffer to obtain a image data and sound data of dynamical changing areas, then convert, composite, and compress said data, the other one of which is: obtaining mapping data of the screen buffer, compressing said data in real time, and converting to a format that is suitable for transmission; corresponding to different format conversion and data compression, wireless human-machine interactive device converts, de-composites, and de-compresses the received data after receiving the data, and pads and display in corresponding display area, or, after receiving the data converts and de-compress the said data.

Specially, the switching step is an automatic switch supporting the first compression type or the second hardware compression type, according to the current event state of host computer, or according to amount of data volume with current compression type, or whether an application is an office application, such as Word, or a multimedia application, such as Media Player.

The invention utilizes the powerful software and hardware function in host computer, and provides mobile office work and wireless entertainment, such that have big economical value. The PC of the invention can realize several functions and is easy to realize and extend new wireless multimedia application. The foregoing is several embodiments; the invention is not limited by these embodiments. Within the spirit and principle of the invention, professionals in the art can make many different schemes to be implemented; all of these update, modification and revision will be covered in the scope of the claims of the invention.

The description of the invention is merely exemplary in nature and, thus, variations that do not depart from the gist of the invention are intended to be within the scope of the invention. Such variations are not to be regarded as a departure from the spirit and scope of the invention.

1. A personal computer (PC) based-on wireless human-machine interactive device, at least comprises: a host computer, a display, and peripherals of the host computer, wherein, a wireless human-machine interactive device is set between the host computer and the peripherals as well as the display; wherein,
the host computer connects with a data capture and compression device and a duplex wireless communication device through buses; the data capture and compression device obtains data to be transmitted to the wireless human-machine interactive device from the host computer, converts format and compresses the data; and then the duplex wireless communication device transmits the compressed data to the wireless human-machine interactive device in wireless mode;
the wireless human-machine interactive device connects with the display and the peripherals of the host computer; the wireless human-machine interactive device includes a CPU, a memory, a display output device, a sound output device, the duplex wireless communication device, a data receiving and decompression device and also bus extended ports and interfaces of the peripherals of the host computer; wherein, the duplex wireless communication device communicates with the host computer; the data receiving and decompression device receives data transferred from the duplex wireless communication device, decompresses and restores the received data, and transfers to the display output device and sound output device to display image and play music;
an event message inputted from the peripheral connected to the wireless human-machine interactive device being transmitted to the host computer in wireless communication mode, and then the host computer simulates and triggers the input event.

2. The PC based on wireless human-machine interactive device according to claim 1, wherein:
the data capture and compression device includes a screen image data backup module, a data dynamic comparison module, a data capture module and a data compression module; the screen image data backup module stores last frame of mapping of a screen buffer in real time; the data dynamic comparison module obtains current frame of mapping of the screen buffer in real time, and compares the current frame of mapping of the screen buffer with last frame stored in the screen image data backup module; the data capture module captures compared dynamic data in certain field and sends the data to the data compression module; the data compression module compresses the data and transfers the compressed data to the duplex wireless communication device; in the wireless human-machine interactive device, the data receiving and decompression device includes two modules: a data decompression module, which decompresses the compressed data transferred from the host computer, and an image-padding module, which pads the dynamic data on appropriate areas of an image.

3. The PC based on wireless human-machine interactive device according to claim 2, wherein: the data compression used in the data compression module is lossless compression and/or lossy compression.

4. The PC based on wireless human-machine interactive device according to claim 1, wherein:
the data capture and compression device of the host computer includes a data capture module and a data compression in real time module; the data capture module is used to obtain a mapping of a screen buffer in real time, and the data compression in real time module makes data compression and format conversion in order to transmit efficiently; the data receiving and decompression module in the wireless human-machine interactive device is data de-compression in real time module which restores data format and decompresses received data.

5. The PC based on wireless human-machine interactive device according to claim 4, wherein:
the data compression in real time module deploys MPGE standards to convert a compressed PS data stream to a TS data stream that is suitable for transmission.

6. The PC based on wireless human-machine interactive device according to claim 1, wherein:
the data capture and compression device includes two channels, and there is a switch device in front of the data capture and compression device;
one channel includes a screen image data backup module, a data dynamic comparison module, a data capture module and a data compression module; the screen image data backup module stores last frame of mapping of said screen buffer in real time; the data dynamic comparison module obtains current frame of mapping of the screen buffer in real time and compares the current the frame of mapping of the screen buffer with the last frame stored in the screen image data backup module; the data capture module captures compared dynamic data in certain field and sends the dynamic data to the data compression module; the data compression module compresses the dynamic data and transfers the dynamic data to the duplex wireless communication device;
another channel includes a data capture module and a data compression in real time module; the data capture module is used to obtain a mapping of the screen buffer in real time, and the data compression in real time module makes data compression and format conversion in order to transmit efficiently;
correspondingly, the data receiving and decompression device in wireless human-machine interactive device also includes two channels:
one channel includes a data decompression module, which decompresses the compressed data from the host computer, and an image-padding module, which pads the dynamic data on appropriate areas of an image;
another channel includes a data decompression in real time module that restores received data to its original format and decompresses received data.

7. The PC based on wireless human-machine interactive device according to claim 6, wherein:
the switch device is a manual switch device or an automatic switch device.

8. The PC based on wireless human-machine interactive device according to claim 7, wherein:
the manual switch device is a switch, a special key or a special command.

9. The PC based on wireless human-machine interactive device according to claim 7, wherein:
the automatic switch device is an adaptive electronic switch according to event triggered by user input message.

10. The PC based on wireless human-machine interactive device according to claim 1, wherein:
the duplex wireless communication device is a wireless network card that at least includes an interface unit, a data coding/decoding unit, a radio modulation/demodulation unit and a radio transmitter/receiver unit.

11. The PC based on wireless human-machine interactive device according to claim 1, wherein:
the wireless human-machine interactive device is independent equipment or combined with a display.

12. The PC based on wireless human-machine interactive device according to claim 11, wherein:
the wireless human-machine interactive device includes a camera and a IP visible-telephone software module inside.

13. The PC based on wireless human-machine interactive device according to claims 1, wherein:
the wireless human-machine interactive device is more than one.

14. The PC based on wireless human-machine interactive device according to claim 1, wherein:
the peripheral of the host computer is a keyboard, a mouse, a touch screen, a handwriting device or a voice input device.

15. The PC based on wireless human-machine interactive device according to claims 1, wherein:
the connection between the wireless human-machine interactive device and the peripheral is a wire mode or a wireless mode.

16. A method of transmitting data for a PC based on wireless human-machine interactive device, wherein, the PC based on wireless human-machine interactive device is as described above, the method comprising:
(1) inputting a user input event message through peripherals connected with wireless human-machine interactive device;
(2) transferring the user input event message from the wireless human-machine interactive device to the host computer in wireless mode;
(3) capturing the user input event message, simulating and triggering the received user input event in the user input event message by the host computer;
(4) converting format of image and sound data streams triggered by the user input event and compressing the image and sound data streams by the host computer, and then transmitting the image and sound data streams to the wireless human-machine interactive device in wireless mode;
(5) restoring the image and sound data streams and sending the image and sound data streams to a display and sound output device by the wireless human-machine interactive device.

17. The method according to claim 16, wherein the wireless communication between the host computer and the wireless human-machine interactive device deploys TCP/UDP/IP or other protocols based on IP.

18. The method according to claim 16, wherein the user input event is captured and coded in an event message manner by the wireless human-machine interactive device, and then transmitted in a wireless mode.

19. The method according to claim 16, wherein the converting format of image and sound data streams and compressing the image and sound data streams includes: comparing continuously mapping data of a screen buffer, obtaining sound and image data of dynamic changing field; then converting format of the sound and image data, synthesizing and compressing the sound and image data; correspondingly, after receiving the data, de-converting, de-synthesizing and decompressing the data by the wireless human-machine interactive device, and then displaying and padding the data on appropriate parts of a screen.

20. The method according to claim 19, wherein the compressing the data streams is lossless compressing.

21. The method according to claim 16, wherein the converting format of image and sound data streams and compressing the image and sound data streams includes: obtaining mapping data of a screen buffer, then compressing the data in real time and converting the data to a format that is suitable for transmission; and after receiving the data, de-converting and decompressing the data by the wireless human-machine interactive device.

22. The method according to claim 21, wherein the compressing is MPGE lossy compressing.

23. The method according to claim 16, before the converting format of image and sound data streams and compressing the image and sound data stream, further including:
a switching step for selecting different data format conversion and compression according to different data streams, one of the selecting steps is to compare continuously mapping data of a screen buffer to obtain image and audio data of image in dynamic changing areas, and then convert format and synthesize and compress the data; the other of the selecting steps is to obtain mapping data of a screen buffer, and then compress the data in real time and convert to a format that is suitable for transmission; corresponding to different format conversion and data compression, wireless human-machine interactive device has different either to receive, de-synthesize and decompress the data and puts displaying data and padded data on appropriate parts of a display, or receive the data and then convert and decompress.

24. The method according to claim 23, wherein the switching step including:
making determination based on a host computer state and data volume to be transferred;
if the data volume is small, a lossless compression method which is only to transfer changed data in real time is deployed; and if data volume is large, a lossy compression method which is only to transfer full screen data in real time is deployed, such to realize the adaptation switch.

25. The method according to claims 23, wherein the switching is a manual switch controlled by switch or key, or an automatic switch which judges according to the setting.

26. The method according to claim 16, wherein, when the wireless human-machine interactive device is more than one, the method further including:
controlling data interaction among the more than one wireless human-machine interactive devices with time-division or frequency-division control.
